(19) United States
(12) Patent Application Publication
(10) Pub. No.: US 2023/0193686 A1
(43) Pub. Date: Jun. 22, 2023

(54) HEAT-INSULATING WINDOW PANEL

(71) Applicant: YAZAKI ENERGY SYSTEM CORPORATION, Tokyo (JP)

(72) Inventor: Takuju Nakamura, Hamamatsu-shi (JP)

(21) Appl. No.: 18/169,143

(22) Filed: Feb. 14, 2023

Related U.S. Application Data
(63) Continuation of application No. PCT/JP2021/030824, filed on Aug. 23, 2021.

(30) Foreign Application Priority Data
Sep. 15, 2020 (JP) 2020-154296

(51) Int. Cl. E06B 3/263; E06B 3/26; E06B 3/54; E06B 3/62

(52) U.S. Cl. CPC E06B 3/26336; E06B 3/26; E06B 3/549; E06B 3/62; E06B 2003/26321; E06B 2003/2615; E06B 2003/26376

(57) ABSTRACT

A heat-insulating window panel includes: a light-transmissive member having light transmissivity; and a panel member including an outdoor substrate that supports the light-transmissive member from an outdoor side via a first elastic body, an indoor substrate that supports the light-transmissive member from an indoor side via a second elastic body without being in contact with the outdoor substrate, and a heat-insulating material disposed between the outdoor substrate and the indoor substrate, and even when a force is applied to one of the outdoor substrate and the indoor substrate in a direction away from the other to move the one in a separating direction, the outdoor substrate and the indoor substrate have a hooking margin for hooking the one on the other.

### CROSS REFERENCE TO RELATED APPLICATIONS

This application is a continuation of PCT application No. PCT/JP2021/030824, which was filed on Aug. 23, 2021 based on Japanese patent application 2020-154296 filed on Sep. 15, 2020, whose contents are incorporated herein by reference. Also, all the references cited herein are incorporated as a whole.

### BACKGROUND OF THE INVENTION

### Technical Field

The present invention relates to a heat-insulating window panel.

### Background Art

In related art, a heat-insulating panel including an outer substrate, an inner substrate, and a heat-insulating material disposed between the outer substrate and the inner substrate has been proposed (see PTL 1). A heat-insulating window panel in which a sash is provided by hollowing out a part of a heat-insulating panel has also been proposed (see PTL 2). Further, a composite sash including an inner metal mold member, an outer metal mold member, and a heat-insulating material interposed between the inner metal mold member and the outer metal mold member has also been proposed (see PTL 3).

### CITATION LIST

### Patent Literature

PTL 1: JP2015-48624A
PTL 2: JP2017-106293A
PTL 3: JPS57-100280A

### SUMMARY

Here, in the heat-insulating window panel described in PTL 2, the sash made of an aluminum material or the like having high thermal conductivity is provided in order to attach a window to the heat-insulating panel, and window glass is held by the heat-insulating panel using the sash. However, with such a configuration, the sash is continuous from an indoor surface to an outdoor surface, and thus heat is transferred through the sash, and a heat-insulating property is lowered.

Therefore, it is conceivable to use the composite sash in which heat conduction through a sash is prevented by disposing the heat-insulating material between the inner metal mold member and the outer metal mold member without bringing the inner metal mold member and the outer metal mold member into contact with each other as described in PTL 3. However, in this case, although a heat-insulating property can be improved, since the inner metal mold member and the outer metal mold member are separate members from each other, when a force is applied to either the inner metal mold member or the outer metal mold member in a direction away from the other, the inner metal mold member or the outer metal mold member may be detached, and when a metal member is detached, a transparent plate member such as window glass supported by the composite sash also is detached. Even if the inner metal mold member and the outer metal mold member are firmly fastened to the heat-insulating material, when the force is applied to either the inner metal mold member or the outer metal mold member in the direction away from the other, a strong tensile force is applied to the heat-insulating material, and in general, a material having a high heat-insulating property has low tensile strength, and thus it is not possible to achieve both the high heat-insulating property and prevention of detachment.

The present invention has been made in order to solve such a problem, and an object thereof is to provide a heat-insulating window panel capable of contributing to prevention of detachment of a transparent plate member while improving a heat-insulating property.

### Solution to Problem

A heat-insulating window panel according to an embodiment includes: a light-transmissive member having light transmissivity; and a panel member including an outdoor substrate that supports the light-transmissive member from an outdoor side via a first elastic body, an indoor substrate that supports the light-transmissive member from an indoor side via a second elastic body without being in contact with the outdoor substrate, and a heat-insulating material disposed between the outdoor substrate and the indoor substrate, and even when a force is applied to one of the outdoor substrate and the indoor substrate in a direction away from the other to move the one in a separating direction, the outdoor substrate and the indoor substrate have a hooking margin for hooking the one on the other.

### BRIEF DESCRIPTION OF THE DRAWINGS

FIG. 1 is a cross-sectional view showing a heat-insulating window panel according to an embodiment of the present invention.

FIG. 2 is an exploded cross-sectional view of the heat-insulating window panel according to the embodiment of the present invention.

FIG. 3 is a cross-sectional view showing a state of stacking of the heat-insulating window panel according to the present embodiment.

FIG. 4 is a plan view showing the heat-insulating window panel according to the present embodiment.

FIG. 5 is a cross-sectional view showing another first example of an outdoor substrate and an indoor substrate.

FIG. 6 is a cross-sectional view showing another second example of the outdoor substrate and the indoor substrate.

### DETAILED DESCRIPTION OF EMBODIMENTS

Hereinafter, the present invention will be described in accordance with a preferred embodiment. The present invention is not limited to the following embodiment, and can be modified as appropriate without departing from the scope of the present invention. In the embodiment to be described below, some configurations are not illustrated or described, but it goes without saying that a known or well-known technique is applied as appropriate to details of an omitted technique within a range in which no contradiction occurs to contents to be described below.

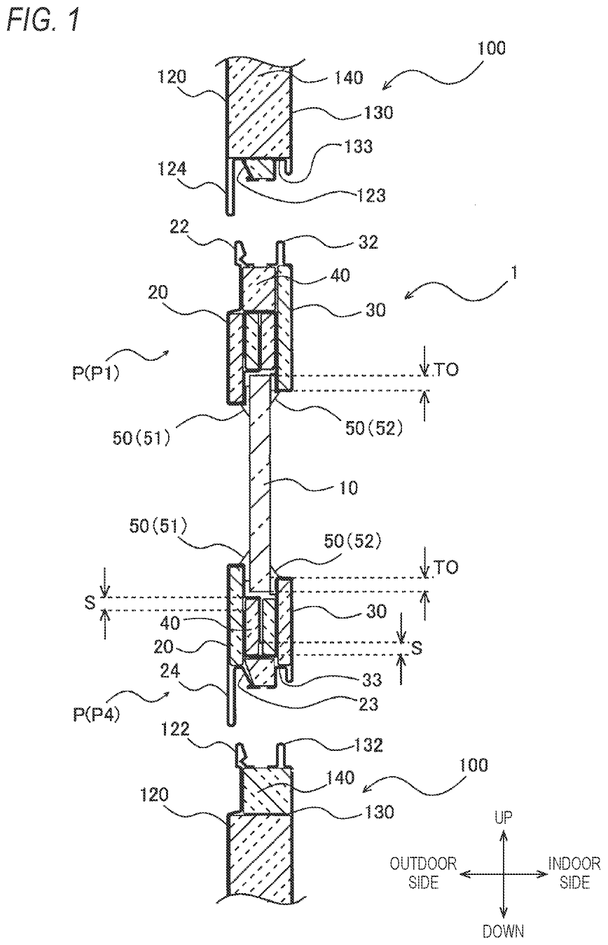

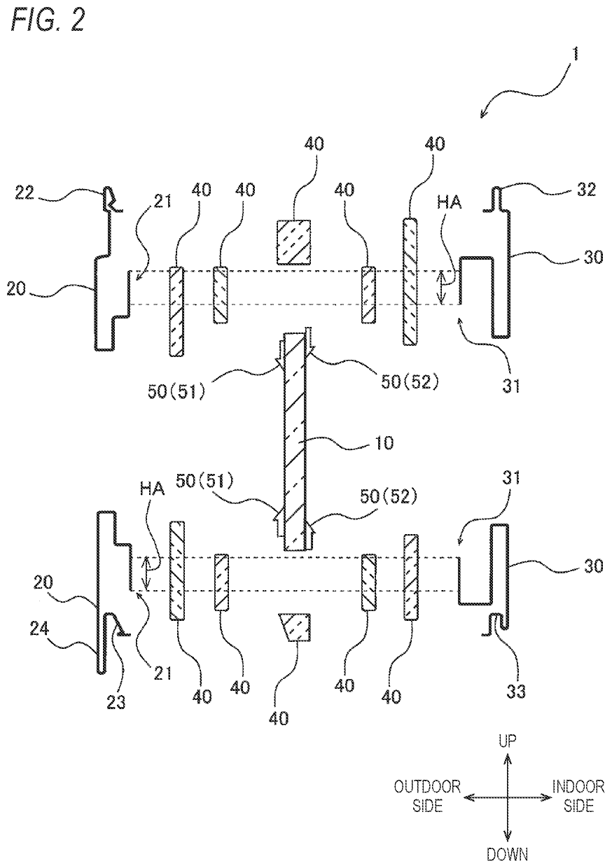

FIG. 1 is a cross-sectional view showing a heat-insulating window panel according to an embodiment of the present invention, and FIG. 2 is an exploded cross-sectional view of the heat-insulating window panel according to the embodiment of the present invention. In FIG. 1, for the sake of description, heat-insulating panels 100 stacked with a heat-insulating window panel 1 is also illustrated. In FIGS. 1 and 2, an example in which the heat-insulating window panel 1 is used as a vertical surface is illustrated, but the heat-insulating window panel 1 may be used as an inclined surface or a horizontal surface for a skylight or the like.

The heat-insulating window panel 1 according to the example shown in FIGS. 1 and 2 schematically includes a light-transmissive member 10, a panel member P, and elastic bodies 50. The panel member P includes outdoor substrates 20, indoor substrates 30, and heat-insulating materials 40. The light-transmissive member 10 is a general single-layer glass plate. The light-transmissive member 10 is not limited thereto, and may be formed of multilayer glass, three-layer glass, or the like.

The outdoor substrate 20 is a plate material serving as an outer wall surface exposed to an outdoor space, and is formed of, for example, a coated Galvalume steel sheet (registered trademark). The outdoor substrate 20 is formed by bending such that a tip portion (hook-shaped portion) 21 (see FIG. 2) is on an indoor side, and has a substantially hook shape in a cross section (cross section shown in FIGS. 1 and 2) in a thickness direction of the panel member P.

The outdoor substrates 20 are formed with a hook portion (fitting portion) 22 at an upper portion and a hook receiving portion (fitted portion) 23 at a lower portion by a bending process, respectively. Further, the outdoor substrate 20 includes a hood portion 24 extending downward so that the hook receiving portion 23 cannot be visually recognized from an outdoor side.

The indoor substrate 30 is a plate material that is disposed to face the outdoor substrate without being in direct contact with the outdoor substrate 20, and that is on an indoor side, and is formed of, for example, a coated Galvalume steel sheet. The indoor substrate 30 is formed by bending such that a tip portion (hook-shaped portion) 31 (see FIG. 2) is on the outdoor side, and has a substantially hook shape in a cross section (cross section shown in FIGS. 1 and 2) in a thickness direction of the panel member P.

The indoor substrates 30 are formed with a protruding portion (fitting portion) 32 at an upper portion and a protruding receiving portion (fitted portion) 33 at a lower portion by a bending process, respectively.

The outdoor substrate 20 and the indoor substrate 30 are not limited to the Galvalume steel sheet as long as they can withstand flame for 60 minutes, and may be formed of other metal plates or the like.

The heat-insulating material 40 is disposed between the outdoor substrate 20 and the indoor substrate 30 and has thermal conductivity of a predetermined value or less (for example, 0.25 W/mK or less, and more preferably 0.1 W/mK or less), and is formed of a hard heat-insulating core such as a calcium silicate board, a gypsum board, a perlite board, a silica board, etc., which can withstand the flame for 60 minutes. Any of these materials does not have high tensile strength but has high compressive strength. The heat-insulating material 40 is divided into a plurality of pieces so as to be disposed between the outdoor substrate 20 and the indoor substrate 30 which have the hook shapes, and the individual heat-insulating materials 40 are disposed in a manner of being incorporated between the substrates 20 and 30.

Here, in the present embodiment, the outdoor substrate 20 supports the light-transmissive member 10 from the outdoor side via a first elastic body 51 formed of a fire-resistant glazing bead or the like. Further, the indoor substrate 30 supports the light-transmissive member 10 from the indoor side via a second elastic body 52 made of a fire-resistant glazing bead or the like. That is, the light-transmissive member 10 is sandwiched between the outdoor substrate 20 and the indoor substrate 30 via the elastic bodies 50. Although the first elastic body 51 and the second elastic body 52 are separate members, the present invention is not particularly limited thereto, and the first elastic body 51 and the second elastic body 52 may be connected to each other as a single member formed of a glazing channel or the like. It is preferable that the elastic body 50 can also withstand to the flame for 60 minutes.

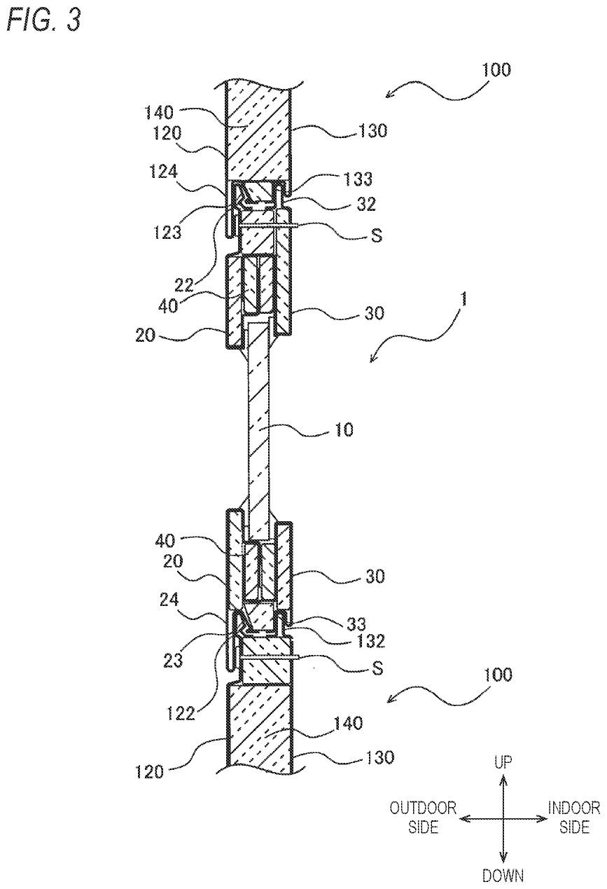

FIG. 3 is a cross-sectional view showing a state of stacking of the heat-insulating window panel 1 according to the present embodiment. As shown in FIG. 3, the heat-insulating window panel 1 is stacked with the heat-insulating panels 100. As shown in FIG. 1, the heat-insulating panel 100 includes an outdoor member 120, an indoor member 130 disposed to face the outdoor member 120 without being in direct contact with the outdoor member 120, and a heat-insulating member 140 sandwiched therebetween without the light-transmissive member 10.

Similar to the outdoor substrate 20 and the indoor substrate 30, the outdoor member 120 and the indoor member 130 are formed by bending Galvalume steel sheets or the like. Similar to the heat-insulating material 40, the heat-insulating member 140 is formed of a hard heat-insulating core such as a calcium silicate board, a gypsum board, or a perlite board, or a heat-insulating core such as mineral wool or polyurethane resin/polyisocyanurate (PUR/PIR).

Such heat-insulating panels 100 include a hook portion 122 on an upper side of the outdoor member 120, and a hook receiving portion 123 and a hood portion 124 extending downward on a lower side of the outdoor member 120, respectively. Further, the heat-insulating panels 100 include a protruding portion 132 on an upper side of the indoor member 130 and a protruding receiving portion 133 on a lower side of the indoor member 130, respectively.

Here, in the heat-insulating window panel 1 according to the present embodiment, as shown in FIG. 3, the hook portion 22 is fitted to the hook receiving portion 123 of the heat-insulating panel 100, and the protruding portion 32 is fitted to the protruding receiving portion 133 of the heat-insulating panel 100. Further, in the heat-insulating window panel 1, the hook receiving portion 23 is fitted to the hook portion 122 of the heat-insulating panel 100, and the protruding receiving portion 33 is fitted to the protruding portion 132 of the heat-insulating panel 100.

As described above, the heat-insulating window panel 1 according to the present embodiment can be stacked with respect to the heat-insulating panel 100 not including a window, and an outer wall including a window can be formed in the same manner as a process of stacking only the heat-insulating panels 100 to form an outer wall in related art.

As shown in FIG. 3, the heat-insulating window panel 1 is fixed to a column or the like by using screws S. The screws S are attached from positions corresponding to back surface sides (indoor sides) of the hood portions 24 and 124 toward the indoor side so as not to be visually recognized from the outdoor side. In an example shown in FIG. 3, the heat-insulating window panel 1 is stacked on the heat-insulating panel 100, but may be stacked on another heat-insulating window panel 1.

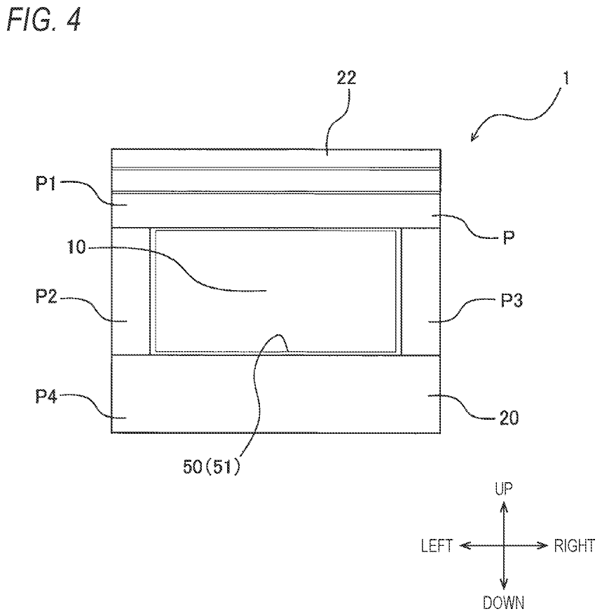

FIG. 4 is a plan view showing the heat-insulating window panel 1 according to the present embodiment. As shown in FIG. 4, the light-transmissive member 10 is provided at a center portion (center side) of the panel member P in a plan view. That is, the light-transmissive member 10 is surrounded in four directions by first to fourth panel members P1 to P4 constituting the panel member P. Here, the first to fourth panel members P1 to P4 are configured separately. The outdoor substrates 20 and the indoor substrates 30 constituting the first and fourth panel members P1 and P4 have a cross-sectional structure in which the substantially hook shapes are engaged as shown in the vertical cross section of FIG. 1. The second and third panel members P2 and P3 also have a horizontal cross section similar to the vertical cross section in FIG. 1, and the outdoor substrate 20 and the indoor substrate 30 have the cross-sectional structure in which the substantially hook shapes are engaged.

In addition, the first panel member P1 is connected to the second and third panel members P2 and P3, each of the second and third panel members P2 and P3 is connected to the first and fourth panel members P1 and P4, the fourth panel member P4 is connected to the second and third panel members P2 and P3, and as a result, the first to fourth panel members P1 to P4 are integrated.

In the present embodiment, a rectangular heat-insulating window panel 1 including one light-transmissive member 10 is shown as an example, but a plurality of light-transmissive members 10 may be arranged side by side with respect to the heat-insulating window panel 1. In this case, middle columns stand between the plurality of light-transmissive members 10, and the middle columns similarly have a cross-sectional structure in which substantially hook shapes are engaged, and are connected to the first and fourth panel members P1 and P4.

Furthermore, in the present embodiment, when the heat-insulating material 40 is removed from the panel member P, a maximum sliding amount when the outdoor substrate 20 and the indoor substrate 30 slide in a direction in which engagement between the tip portions 21 and 31 (see FIG. 2) of the outdoor substrate 20 and the indoor substrate 30 becomes deeper is set to be less than a hooking margin TO (see FIG. 1) in which the outdoor substrate 20 and the indoor substrate 30 support the light-transmissive member 10. Here, the maximum sliding amount is a distance S shown in FIG. 1. In FIG. 1, since the hooking margin TO is shorter on an indoor substrate 30 side, the distance S is set to be less than the hooking margin TO on the indoor substrate 30 side.

Furthermore, in the present embodiment, a distance (distance in the thickness direction of the panel member P) between the tip portions 21 and 31 of the substrates 20 and 30 is also made appropriate.

Next, an operation of the heat-insulating window panel 1 according to the present embodiment will be described.

First, as shown in FIGS. 1 to 3, in the heat-insulating window panel 1, the light-transmissive member 10 is sandwiched between the outdoor substrates 20 and the indoor substrates 30 via the elastic bodies 50. Accordingly, in the heat-insulating window panel 1, the light-transmissive member 10 is supported by the outdoor substrate 20 and the indoor substrate which do not include a sash made of an aluminum material or the like and are not in direct contact with each other, and a decrease in a heat-insulating property is prevented. In addition, in the present embodiment, if the substrates 20 and 30 and the heat-insulating material 40 (and further the elastic body 50) are made of a material capable of withstanding the flame for 60 minutes, it is also possible to exhibit fire resistance.

Further, the heat-insulating window panel 1 is not one in which the heat-insulating panel 100 is hollowed out on site and the light-transmissive member 10 is fitted together with the sash made of the aluminum material or the like, and the light-transmissive member 10 is sandwiched in advance by the outdoor substrates 20 and the indoor substrates 30 via the elastic bodies 50. Moreover, since the heat-insulating window panel 1 includes the hook portion 22, the hook receiving portion 23, the protruding portion 32, and the protruding receiving portion 33, the heat-insulating window panel 1 can be stacked with the heat-insulating panel 100 and another heat-insulating window panel 1, and the outer wall including the window can be formed by stacking without performing a hollowing operation or the like on site.

As shown in FIG. 4, the light-transmissive member 10 is provided in the center portion of the panel member P instead of an end portion thereof, and the outdoor substrates 20 and the indoor substrates 30 are integrally connected on both sides sandwiching the light-transmissive member 10 (that is, the first panel member P1 and the fourth panel member P4, and the second panel member P2 and the third panel member P3 are integrally connected). Therefore, in a state in which the panel member P is seen in the plan view, even if a force acts on the outdoor substrate 20 or the indoor substrate 30 on one side of the light-transmissive member 10 in a direction away from the light-transmissive member 10, movement is restricted by the other side integrally connected the one side, and the one side is prevented from being detached from the light-transmissive member 10. For example, as shown in FIG. 1, due to the hook-shaped engagement with the heat-insulating material 40 interposed therebetween, the outdoor substrate of the first panel member P1 cannot be shifted upward with respect to the indoor substrate of the first panel member P1, the outdoor substrate 20 of the fourth panel member P4 cannot be shifted downward with respect to the indoor substrate 30 of the fourth panel member P4, and therefore, the outdoor substrates 20 of the first to fourth panel members P1 to P4 which are integrally connected cannot be shifted upward and downward with respect to the light-transmissive member 10 and the indoor substrates 30. The same applies to the second and third panel members P2 and P3, and the outdoor substrates 20 of the first to fourth panel members P1 to P4 that are integrally connected are not shifted to left or right with respect to the light-transmissive member 10 or the indoor substrates 30. Accordingly, as described above, even if the force acts in the direction (one side) in which the one side is detached from the light-transmissive member 10, the movement can be restricted by the other side, thereby contributing to preventing detachment of the light-transmissive member 10.

Further, as shown in FIGS. 1 to 3, the outdoor substrate 20 and the indoor substrate 30 have the substantially hook shapes, and the tip portions 21 and 31 are engaged with each other, and thus even if a force is applied to one of the outdoor substrate 20 and the indoor substrate in a direction away from the other to move the one in a separating direction, the outdoor substrate 20 and the indoor substrate 30 have a hooking margin HA (see FIG. 2) for hooking the one on the other. In particular, since the outdoor substrate 20 and the indoor substrate 30 sandwich the heat-insulating material 40 in a state where the tip portions 21 and 31 are engaged with each other, for example, even if a force is applied to the outdoor substrate 20 in an outdoor direction, this force also acts on the indoor substrate 30 to prevent the outdoor substrate 20 from being detached in the outdoor direction. That is, one of the outdoor substrate 20 and the indoor substrate 30 sandwiching the light-transmissive member 10 is prevented from being detached in a normal direction of the panel member P.

As described above, in any case where a force for relatively displacing the outdoor substrate 20 or the indoor substrate 30 in an in-plane direction or an out-of-plane direction is applied, since the outdoor substrate 20 and the indoor substrate 30 have the hook shapes, a compressive force, not the tensile force, acts on the heat-insulating material 40. Since the heat-insulating material 40 is not resistant to the tensile force but resistant to compression, the heat-insulating material 40 can withstand the compressive force. In particular, such an action can be exhibited even when the hard heat-insulating core, which is the heat-insulating material 40, is broken by an external force. In related art, when the hard heat-insulating core is broken, the outdoor substrate 20 and the indoor substrate 30 may peel off. However, in the present embodiment, for example, even if the heat-insulating material 40 is broken, if the heat-insulating material 40 is present between the outdoor substrate 20 and the indoor substrate 30, the force that causes the substrates 20 and 30 to separate from each other also acts on the other substrates 20 and 30, and thus it is possible to prevent the substrates 20 and 30 from being shifted or peeled off.

Further, even if the heat-insulating material 40 is crushed and falls down, the outdoor substrates 20 connected between the panel members P1 to P4 and the indoor substrates 30 connected between the panel members P1 to P4 cannot be largely displaced in any direction of up, down, left, right, and away from each other due to the hook-shaped engagement. A magnitude of the displacement is appropriately designed from a magnitude of the hooking margin TO (see FIG. 1) of the light-transmissive member 10 with respect to the substrates 20 and 30, and the light-transmissive member 10 does not come off.

This point will be described in detail. First, in the present embodiment, when the heat-insulating material 40 is removed from the panel member P, the maximum sliding amount (distance S) when the outdoor substrate 20 and the indoor substrate 30 slide in the direction in which the engagement between the tip portions 21 and 31 (see FIG. 2) of the outdoor substrate 20 and the indoor substrate 30 becomes deeper is set to be less than the hooking margin TO (see FIG. 1). A vertical distance between the tip portions 21 and 31 is designed to be longer than the maximum sliding amount (distance S). This prevents the light-transmissive member from being detached due to sliding in vertical and horizontal directions. For example, it is assumed that the heat-insulating material 40 is crushed and falls down, and the indoor substrate slides upward. However, even if the indoor substrate 30 slides to the maximum and a sliding amount remains at the distance S, and the indoor substrate 30 does not slide beyond the hooking margin TO. The hook shapes of the tip portions 21 and 31 also do not lose the hooking margin HA. Accordingly, it is possible to prevent the light-transmissive member 10 from coming off due to the upward sliding of the indoor substrate 30. The same applies not only to movement of the fourth panel member P4, but also to the first to third panel members P1 to P3, and thus when the heat-insulating material 40 is crushed and falls down, the light-transmissive member 10 can be prevented from being detached even if the first to third panel members P1 to P3 slide in any of the vertical and horizontal directions.

When the heat-insulating material 40 is crushed and falls down, the light-transmissive member 10 is inclined. Therefore, when the distance S (maximum sliding amount) between the substrates 20 and 30 is slightly shorter than the hooking margin TO or when the vertical distance between the tip portions 21 and 31 is slightly longer than the maximum sliding amount (distance S), the light-transmissive member 10 may be detached due to the inclination of the light-transmissive member 10. Therefore, it is preferable to set the distance S to be less than the hooking margin TO and to set the distance S to be less than a hooking margin TO−α (α is a predetermined value corresponding to a maximum inclination) in consideration of the inclination of the light-transmissive member 10. The vertical distance between the tip portions 21 and 31 is preferably equal to or greater than the maximum sliding amount (distance S)+α (a is the predetermined value corresponding to the maximum inclination). Accordingly, in the case where the heat-insulating material 40 is crushed, the light-transmissive member 10 can be prevented from be detached not only when the substrates 20 and 30 slide in the vertical and horizontal directions, but also when the substrates 20 and 30 are separated from each other (that is, when the tip portions 21 and 31 come into contact with each other).

As described above, according to the heat-insulating window panel 1 of the present embodiment, since the outdoor substrates 20 and the indoor substrates 30 support the light-transmissive member 10 from the both sides via the first and second elastic bodies 51 and 52, the heat-insulating window panel 1 can support the light-transmissive member 10 by the outdoor substrate 20 and the indoor substrate 30 which do not include the sash and are not in direct contact with each other, and can improve the heat-insulating property. In addition, even when the force is applied to the one of the outdoor substrate 20 and the indoor substrate 30 in the direction away from the other to move the one in the separating direction, the outdoor substrate 20 and the indoor substrate 30 have the hooking margin HA for hooking the one on the other, and thus even if the force is applied in the direction in which the outdoor substrate 20 and the indoor substrate 30 are separated from each other, the hooking margin HA prevents the outdoor substrate 20 and the indoor substrate 30 from separating from each other. Accordingly, it is possible to provide the heat-insulating window panel 1 capable of contributing to the prevention of the light-transmissive member 10 from being detached while improving the heat-insulating property.

Since the outdoor substrate 20 and the indoor substrate 30 having the hook shapes sandwich the heat-insulating material 40 therebetween in the state where the outdoor substrate and the indoor substrate 30 are engaged with each other in a panel thickness direction, when the force is applied in the direction in which the outdoor substrate 20 and the indoor substrate are separated from each other, not only the separation of the outdoor substrate 20 and the indoor substrate 30 from each other is prevented by the engagement of the tip portions 21 and 31, but also the compressive force is applied to the heat-insulating material 40. Since the heat-insulating material 40 is strong against the compression and weak against the separation in many cases, damage to the heat-insulating material 40 can be easily prevented by adopting a structure in which the compressive force is applied.

When the panel member P is seen in the plan view, the outdoor substrates 20 on the both sides sandwiching the light-transmissive member 10 are integrally connected to the indoor substrates 30 on the both sides sandwiching the light-transmissive member 10, respectively, and thus even when the outdoor substrate 20 or the indoor substrate 30 on the one side of the light-transmissive member 10 tries to separate from the light-transmissive member 10 from the light-transmissive member 10 in the plan view, one side of the outdoor substrate 20 or the indoor substrate 30 is restricted from moving by the other side and cannot be separated from the light-transmissive member 10, and the light-transmissive member 10 can be prevented from being detached.

Since the distance S (maximum sliding amount) is set to be less than the hooking margin TO in which the outdoor substrate 20 and the indoor substrate 30 support the light-transmissive member 10, even if the heat-insulating material 40 is crushed and falls down and the outdoor substrate 20 or the indoor substrate 30 slides to the maximum, the sliding amount thereof is less than the hooking margin TO. Since the vertical distance between the tip portions 21 and 31 is set to be equal to or greater than the maximum sliding amount (distance S), even if the heat-insulating material 40 is crushed and falls down and the outdoor substrate 20 or the indoor substrate 30 slide to the maximum, the sliding amount thereof is less than the hook-shaped hooking margin. Accordingly, it is possible to prevent the light-transmissive member 10 from being detached due to such the sliding.

In particular, considering that the heat-insulating material 40 is crushed and falls down and the outdoor substrate 20 and the indoor substrate 30 are separated from each other (tip portions 21 and 31 approach each other), if the distance S (maximum sliding amount) is set to be less than the hooking margin TO−α (a is the predetermined value corresponding to the maximum inclination) and the vertical distance between the tip portions 21 and 31 is set to be equal to or greater than the maximum sliding amount (distance S)+α (α is the predetermined value corresponding to the maximum inclination), the light-transmissive member 10 can be prevented from being detached even if the outdoor substrate 20 or the indoor substrate 30 slides to the maximum and is separated to the maximum.

Since the hook portion 22, the hook receiving portion 23, the protruding portion 32, and the protruding receiving portion 33 which can be fitted to end portion sides of the heat-insulating panels 100 are provided, the heat-insulating window panel 1 can be stacked on the heat-insulating panel 100 or another heat-insulating window panel 1, and the outer wall including the window can be formed in the same manner as in the process of stacking the heat-insulating panels 100 to form the outer wall. That is, it is possible to reduce a work burden on site without forming a hole in the heat-insulating panel 100 and providing the light-transmissive member 10 after the outer wall is formed only by the heat-insulating panel 100.

The present invention has been described based on the embodiment, but the present invention is not limited to the embodiment described above and can be appropriately modified without departing from the spirit of the present invention, and known and well-known techniques may be combined within a possible range.

For example, in an example shown in FIG. 4, the light-transmissive member 10 is located at a center of the heat-insulating window panel 1, and the present invention is not limited to thereto, and may be provided at a slightly separated position in the vertical and horizontal directions. The outdoor substrate 20, the indoor substrate 30, and the heat-insulating material is not necessarily required to withstand the flame for 60 minutes, and the glazing bead and the glazing channel is not required to be fire resistant.

Further, in order to facilitate attachment of the light-transmissive member 10, an opening of the outdoor substrate 20 or the indoor substrate 30 may be made larger than the light-transmissive member 10, and another detachable member (a part of the outdoor substrate or the indoor substrate 30) to which the glazing bead is attached may be fixed so as to form an opening smaller than the light-transmissive member 10, thereby providing the hooking margin TO.

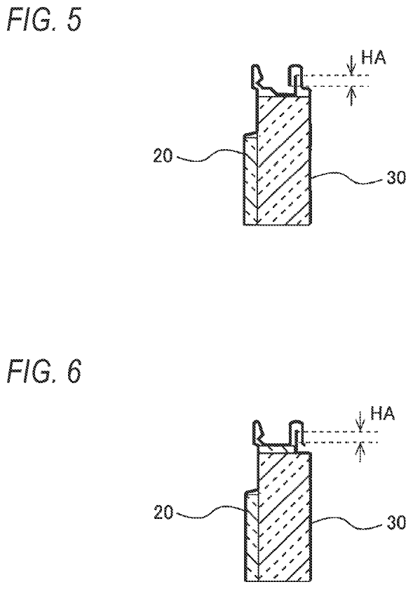

In the present embodiment, the outdoor substrate 20 and the indoor substrate 30 have substantially hook shapes and are engaged with each other with the heat-insulating material 40 interposed therebetween, and the tip portions 21 and 31 constitute the hooking margin HA, but the present invention is not limited thereto, and as long as the hooking margin HA is constituted, the present invention is not limited to the above-described shapes. FIGS. 5 and 6 are cross-sectional views showing other examples of the outdoor substrate 20 and the indoor substrate 30, in which FIG. 5 shows a first example and FIG. 6 shows a second example. As shown in FIG. 5, the outdoor substrate 20 and the indoor substrate 30 may form the hooking margin HA without sandwiching the heat-insulating material 40 therebetween. As long as the hooking margin HA is constituted as in the case of the indoor substrate 30 shown in FIG. 6, the shapes may not be the hook shapes.

According to the present invention, it is possible to provide a heat-insulating window panel capable of contributing to prevention of detachment of a transparent plate member while improving a heat-insulating property.

Although various embodiments have been described above with reference to the drawings, it is needless to say that the present invention is not limited to these examples. It will be apparent to those skilled in the art that various changes and modifications may be conceived within the scope of the claims. It is also understood that the various changes and modifications belong to the technical scope of the present invention. In addition, respective constituent elements in the embodiments described above may be freely combined without departing from the gist of the invention.

1. A heat-insulating window panel comprising:
a light-transmissive member having light transmissivity; and
a panel member including an outdoor substrate that supports the light-transmissive member from an outdoor side via a first elastic body, an indoor substrate that supports the light-transmissive member from an indoor side via a second elastic body without being in contact with the outdoor substrate, and a heat-insulating material disposed between the outdoor substrate and the indoor substrate, wherein
even when a force is applied to one of the outdoor substrate and the indoor substrate in a direction away from the other to move the one in a separating direction, the outdoor substrate and the indoor substrate have a hooking margin for hooking the one on the other.

2. The heat-insulating window panel according to claim 1, wherein
in a cross section in a thickness direction of the panel member, the outdoor substrate and the indoor substrate have hook shapes, and the outdoor substrate and the indoor substrate sandwich the heat-insulating material therebetween in a state where hook-shaped portions are engaged in the thickness direction.

3. The heat-insulating window panel according to claim 2, wherein
the light-transmissive member is provided on a center side of the panel member in a plan view, and
in the plan view of the panel member, the outdoor substrates on both sides sandwiching the light-transmissive member are integrally connected, and the indoor substrates on the both sides sandwiching the light-transmissive member are integrally connected, respectively.

4. The heat-insulating window panel according to claim 2, wherein
when the heat-insulating material is removed from the panel member, a maximum sliding amount when the outdoor substrate and the indoor substrate slide in a direction in which engagement of the hook-shaped portions is deeper is set to be less than a hooking margin in which the outdoor substrate and the indoor substrate support the light-transmissive member.

5. The heat-insulating window panel according to claim 2, wherein
each of the outdoor substrate and the indoor substrate includes a fitting portion or a fitted portion on an end portion side thereof so as to be fitted to an end portion of at least one of another heat-insulating window panel and a heat-insulating panel including an outdoor member, an indoor member, and a heat-insulating member sandwiched therebetween without the light-transmissive member.
